(19) United States
(12) Patent Application Publication
(10) Pub. No.: US 2003/0200281 A1
(43) Pub. Date: Oct. 23, 2003

(54) Method for displaying text utilizing an information processing apparatus

(76) Inventor: Shen Yu Wu, Taipei (TW)

Correspondence Address: JACOBSON HOLMAN PLLC, 400 SEVENTH STREET N.W., SUITE 600, WASHINGTON, DC, 20004, US

(21) Appl. No.: 10/127,420

(22) Filed: Apr. 23, 2002

(51) Int. Cl. G06F 15/16

(52) U.S. Cl. 709/218

(57) ABSTRACT

A method for presenting text utilizing an information-processing apparatus which downloading the text from an electronic bookstore website. The text displaying in the character running mode so that only a part of the whole information is displayed sequentially on the display unit, and the user can easily read. The speed of the character running can be controlled by the user through pressing a scroll bar, or even paused by pressing a pause key.

### BACKGROUND OF THE INVENTION

1. Field of the Invention

The invention generally relates to an information presenting method, and particularly relates to a method for text displaying utilizing an information-processing apparatus.

2. Related Art

Recently, information can be downloaded in electronic manners or through networks. For example, electronic books are stored in digital formats with some media, such as optical discs, IC memory cards, flash memories or web severs on networks. The electronic files can be read through electronic devices, such as portable computers, WAP mobile phones, GPRS phones or even the newest 3G phones. Since the electronic books are digital information that require only storage media, they have advantages of powerful function, low cost, easy access and portability.

With the aforesaid advantages, electronic books have been fast developed. The contents and formats of electronic books become versatile. As the electronic books are developed with similar concepts of traditional books, most electronic books include a majority of text and parts of sound, images, animations, network activities, interaction or information searching.

In other words, the current electronic books are mainly presented with static texts. Though the static texts can be read from the display of electronic devices, there are some limitations. Especially when information is displayed on a device, such as a personal digital assistant (PDA), the limited area of the display of PDA makes text-reading difficult. Some mobile phones include PDA functions. The display is further smaller and more difficult for reading. Moreover, when using a PDA to download information from a network, due to the slow baud rate, it usually costs a long time to access a whole document. Therefore, there is a need for partial and in-time fetching of network information through an information-processing apparatus.

### SUMMARY OF THE INVENTION

The object of the invention is to provide a method for displaying text utilizing an information-processing apparatus. The method makes text information shift on the display of the information-processing apparatus so that a user can read the information portion by portion whenever the information comes from the apparatus itself or from a network.

Another object of the invention is to provide a method for displaying text information on an information-processing apparatus. The text moves on a display of the apparatus so that only a part of a whole information is displayed sequentially on the limit area of the display, so the user can easily read. The speed of the character running can also be controlled, or even paused, by the user

A method for presenting text information in a character running mode according to the invention applies to an information-processing apparatus, especially when the apparatus accesses information from a network site. The method includes the following steps. First, connecting to a network site. Then, selecting the information. Inputting a text-character running command for reading. And finally, downloading and displaying the information sequentially. After the step of inputting the text-character running command, a step of selecting a portion of the information is also included.

In the step of downloading and displaying information, a further step of controlling the speed of character running can be included. The speed of character running is operated through a scroll bar. For example, scrolling up to increase speed and scrolling down to decrease speed, or the reverse. A pause key is also used to pause the character running, and a resume key is used to resume the prior setting. During operation, the connecting status is monitored. If the connection is broken or off, the character running will be stopped and reconnection will be made.

The invention is especially applicable to display information of electronic books. The information-processing apparatus can be a personal digital assistant, a mobile communication device, or a portable computer.

### BRIEF DESCRIPTION OF THE DRAWINGS

The invention will become more fully understood from the detailed description given herein below. However, this description is for purposes of illustration only, and thus is not limitation of the invention, wherein:

FIG. 1 is a block diagram of an information-processing apparatus applying the invention;

FIG. 2 is a main flowchart showing an embodiment of the invention; and

FIG. 3 is a flowchart showing a partial process for controlling text-character running speed in the invention.

### DETAILED DESCRIPTION OF THE INVENTION

The invention provides a method for presenting text information in a character running mode on an information-processing apparatus The information-processing apparatus can be a personal digital assistant, a mobile communication device, or a portable computer. The following description takes a personal digital assistant as an example, and the text information is of an electronic book located at a network site.

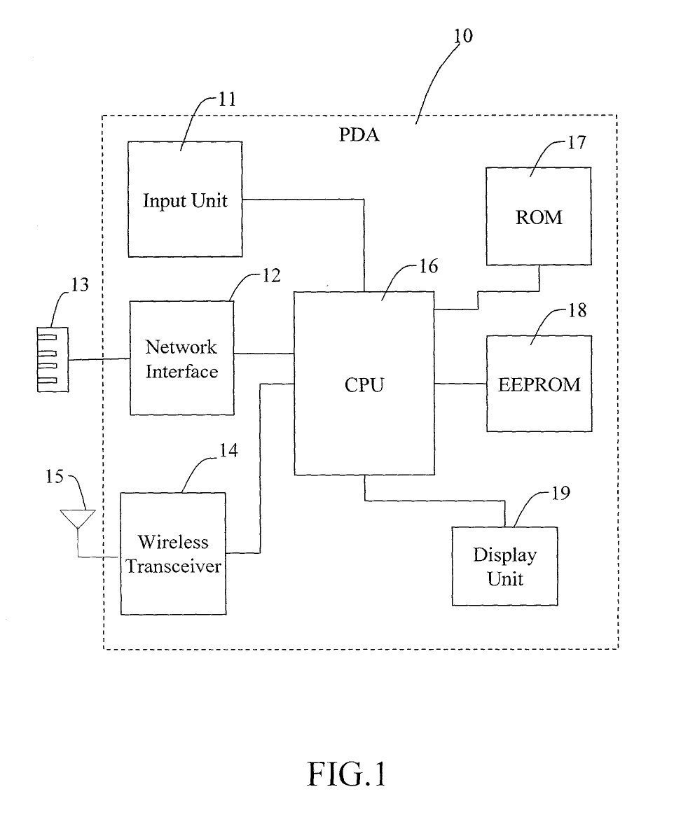

As shown in FIG. 1, a PDA (Personal digital assistant) 10 is composed of an input unit 11, a network interface 12, a network connector 13, a wireless transceiver 14, an antenna 15, a central processing unit 16, a read-only memory unit 17, a EEPROM (Electrically Erasable Programmable Read-Only Memory) 18 and a display unit 19. The input unit 11 is used for input of user's commands. It usually includes a touch panel and some basic keys. The network interface 12 and the network connector 13 are used to connect with a network, such as Internet. The wireless transceiver 14 and the antenna 15 are used for wireless communication or wireless connection to the Internet. The central processing unit 16 controls the whole operation. The read-only memory unit 17 is used for storing information of the operation system. The EEPROM 18 is used for storing text temporary information from the network. The display unit 19 is used for displaying the text and the image information.

Through the aforesaid construction, the PDA 10 is capable of displaying text information of an electronic book in a character running mode. The text information is downloaded from a network connected through the network interface 12 and the network connector 13 or via the wireless transceiver 14 and the antenna 15. The read-only memory unit 17 stores a software program for operating the process of the invention. When the central processing unit 16 executes the software program, it links and downloads text information from a network, stores the information in the EEPROM 18 and displays it in a character running mode through the display unit 19. The capacity of the EEPROM 18 can be smaller since text information is downloaded and displayed partially and sequentially from the network. Therefore, when the network is down, the character running will stop, and the network connection has to be rebuilt for further display.

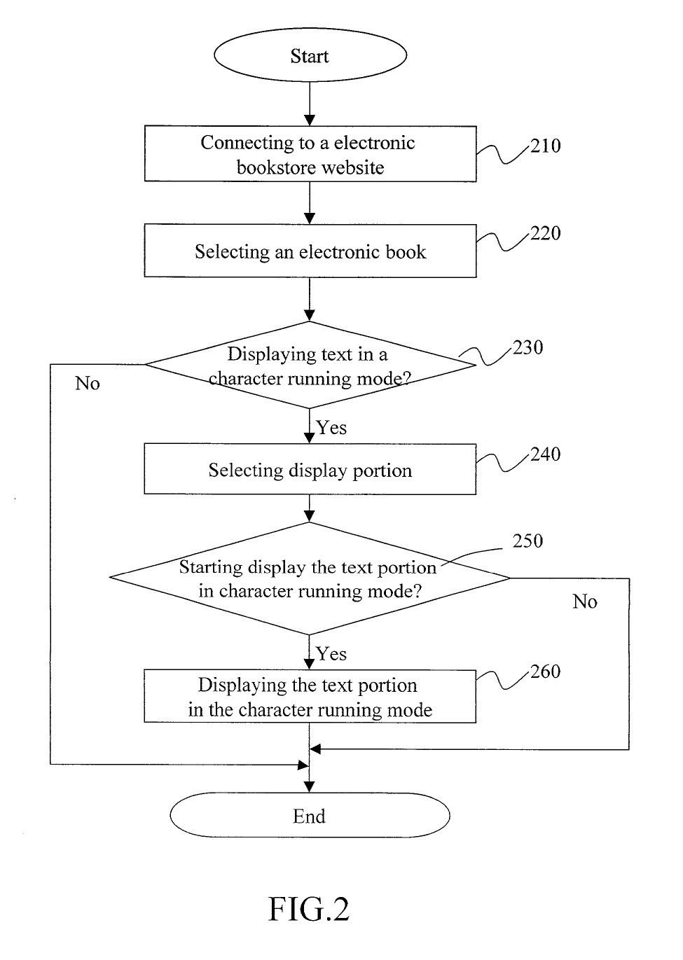

The detailed process of the invention is illustrated in FIG. 2. The process of operation includes the following steps. First, connecting to an electronic bookstore website (step 210). Then, selecting an electronic book (step 220). Displaying text in a character running mode? (step 230). If yes, selecting the portion to be displayed (step 240). Starting display the text portion in character running mode (step 250). Then, displaying the text portion in the character running mode (step 260).

Also referring to FIG. 1, when starting, the PDA 10 is linked to the electronic bookstore website (step 210). After connecting, an electronic book is selected (step 220). The display unit 19 shows a message, like “Do you want to use character running mode?” (step 230). The user may decide “yes” by pressing a certain key to start further processes (inputting a text-character running command), or decide “no” by pressing another key to stop the process. After the character running mode id decided, any available electronic book on the network is displayed in the web page for the user to choose. After the item is selected (step 240), the display unit 19 shows a message for the user whether starting display the text portion in character running mode (step 250). After ensuring by pressing a certain key, the text portion is downloaded and displayed in the character running mode (step 260). Otherwise, the user presses another key to stop the process.

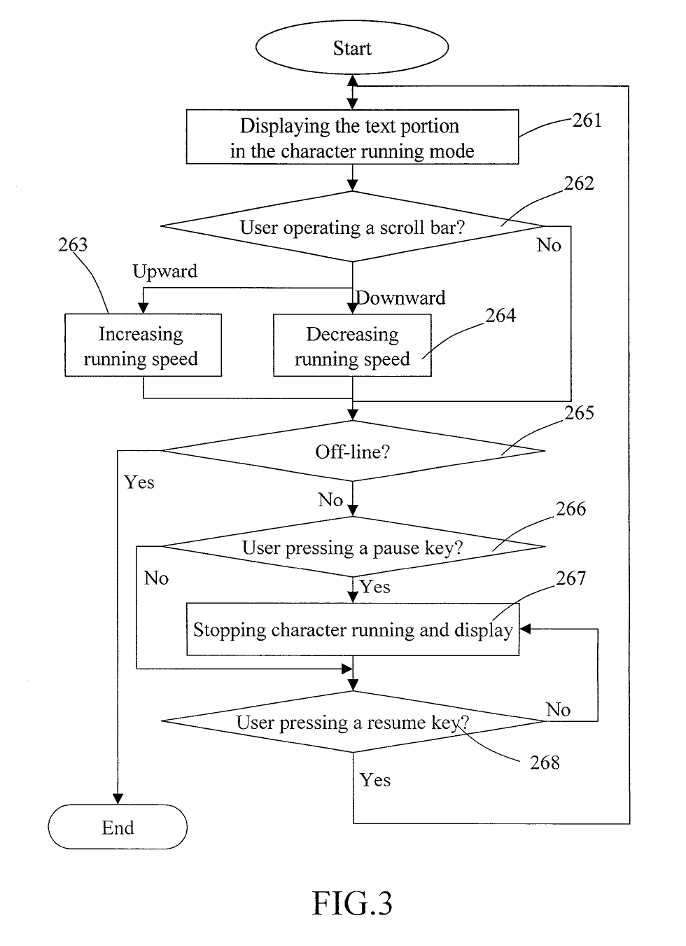

In the aforesaid step of downloading and displaying text in the character running mode (step 260), detailed control procedures are included, as illustrated in FIG. 3. The control starts from displaying text in the character running mode (step 261). Then, checking whether user is operating a scroll bar (step 262). Speeding up the character running when the scroll bar is moved upward (step 263), and lowering the character running speed when the scroll bar is moved downward (step 264). Checking if the connection is being stopped (step 265) or being paused by a pause key (step 266) so as to stop the character running and display (step 267). During pause, checking if a resume key is being pressed (step 268) so as to resume the character running to display the text.

When a personal digital assistant displays the text portion in the character running mode (step 261), the text portion is displayed in a preset speed which may not be suitable for certain users. Therefore, a speed control process is provided. Different control manners can be achieved in accordance with the operational mechanisms of the personal digital assistants. For example, if the personal digital assistant has a scroll bar, scroll-up will speed up the character running, and scroll-down will slow down the character running. Therefore, the scroll bar is monitored if user is operating the scroll bar (step 262), and speed up or slow down will be made (steps 263, 264), or the speed be remained. Further, the personal digital assistant monitors the connecting condition (step 265). If the connection is accidentally off, the character running will be stopped, and a warning message will be generated to inform the user for reconnection.

Under the normal connection and operation, the personal digital assistant monitors if a pause key is being pressed by the user (step 266) so as to stop the character running and the displaying. In that case, the user can take a rest from reading. After then, by pressing a resume key (step 268), the text resumes character running. Thus the control loop proceeds.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for displaying text utilizing an information-processing apparatus, for downloading the text from a website and displaying, comprising steps of:
connecting to a network;
selecting said texts;
inputting a text-character running command for displaying said designated text; and
partially and sequentially downloading said designated text and displaying in a character running mode.

2. The method of claim 1, wherein said information-processing apparatus is selected from the group consisting of personal digital assistants, mobile communication devices and portable computers.

3. The method of claim 1, wherein said step of downloading and displaying the designated text further comprising a step of controlling the character running speed of the text displaying.

4. The method of claim 3, wherein said speed of the character running is controlled by operating a scroll bar.

5. The method of claim 1, further comprising a step of pausing said the character running when being operated by a pause key; and resuming the character running when being operated by a resume key.

6. The method of claim 1, further comprising steps of monitoring said network connection, stopping said the character running when being disconnected and reconnecting to said network after being disconnected.

7. A method for displaying text utilizing an information-processing apparatus, for downloading a electronic text from an electronic bookstore website and displaying in a character running mode, comprising steps of:
inputting a text-character running command for display of said electronic text;
selecting contents of said electronic text for display;
partially and sequentially downloading said designated contents of electronic text; and
displaying said designated contents in a character running mode.

8. The method of claim 7, wherein said step of downloading and displaying the designated contents of electronic text further comprising a step of controlling the character running speed of the text displaying.

9. The method of claim 8, wherein said speed of the text displaying is controlled by operating a scroll bar.

10. The method of claim 9, wherein said scroll bar provides a scroll-up command for increasing the character running speed of the text displaying, and a scroll-down command for decreasing the character running speed.

11. The method of claim 9, wherein said scroll bar provides a scroll-up command for decreasing the character running speed of the text displaying, and a scroll-down command for increasing the character running speed.

12. The method of claim 7, further comprising a step of pausing said the character running when being operated by a pause key; and resuming the character running when being operated by a resume key.

13. The method of claim 7, further comprising steps of monitoring said network connection, stopping said character running when being disconnected and reconnecting to said network after being disconnected.

14. A method for display text utilizing a personal digital assistant, for downloading a electronic text from a electronic bookstore website and displaying in a character running mode, comprising steps of:
inputting a text-character running command for displaying said electronic text;
selecting contents of said electronic text for display;
partially and sequentially downloading said designated contents of electronic text; and
displaying said designated contents in a character running mode.

15. The method of claim 14, wherein said step of downloading and displaying the designated contents of the electronic text further comprising a step of controlling the character running speed of the text displaying.

16. The method of claim 15, wherein said speed of the text displaying is controlled by operating a scroll bar.

17. The method of claim 16, wherein said scroll bar provides a scroll-up command for increasing the character running speed of the text displaying, and a scroll-down command for decreasing the character running speed.

18. The method of claim 16, wherein said scroll bar provides a scroll-up command for decreasing the character running speed of the text displaying, and a scroll-down command for increasing the character running speed.

19. The method of claim 14, further comprises a step of pausing said character running when being operated by a pause key; and resuming the character running when being operated by a resume key.

20. The method of claim 14, further comprises steps of monitoring said network connection, stopping said character running when being disconnected and reconnecting to said network after being disconnected.
